(19) United States
(12) Patent Application Publication
(10) Pub. No.: US 2011/0120435 A1
(43) Pub. Date: May 26, 2011

(54) CAR ENGINE AIR-INTAKE UNIT

(76) Inventor: Chung-Yu YANG, Taipei City (TW)

(21) Appl. No.: 12/939,433

(22) Filed: Nov. 4, 2010

(30) Foreign Application Priority Data
Nov. 20, 2009 (TW) 098139499

(51) Int. Cl. F02M 29/00

(52) U.S. Cl. 123/590

(57) ABSTRACT

A car engine air-intake unit being provided on the inner rim of an intake tube, it comprises at least a main body in a shape of round sheet, the main body is provided thereon with a plurality of current guides and current guiding plates to guide air flow to enter the intake tube and to flow and rotate, and blades are provided which protrude out of the main body and extend from the current guiding plates to increase the rotating angle and stroke of the guided air flow. The present invention can be used in cooperation with any of various specific air-intake tubes, and can make assembling and adjusting by using different air taking in amount and any of various air-intake tubes of different bores; it has the advantage of convenience of use.

### BACKGROUND OF THE INVENTION

1. Field of the Invention

The invention relates to a unit for a car engine, and especially to a car engine air-intake unit able to strengthen scattering molecules of air flow.

2. Description of the Prior Art

For the purpose of getting larger air intake amount when an engine runs with a high speed, there have been various current guides provided on the front ends of intake tubes in the markets, in order to render air entering each intake tube to flow and rotate with a specific angle; such a flowing and rotating air current can get through with a higher speed when it enters an engine, thereby can increase the intake amount to the engine, and thereby an engine combustion chamber can get better combustion and bursting effect.

Each of the above mentioned conventional current guides may have a function of speeding up air intake, however, by inferior structural designing, it has a defect of having the air flow near the axis of the intake tube and the flow far from the axis of the intake tube distributed un-uniformly; such un-uniformity may make a situation, that is, when a user adds air catalyst or some other combustion supporting material (for instance nitrogen oxide (N₂O)) on the intake end of the engine, the air catalyst or the combustion supporting material will be unable to uniformly diffuse for giving its effect.

Hence there further have been a kind of improved current guide in the markets, such as is shown in FIG. 1, the current guide at least comprises a main body 1 in a shape of round sheet, a ring 2 is provided outside of the main body 1 to be fixed on the inner rim of an intake tube 3, the ring 2 is provided therein with a plurality of current guiding holes 4, the current guiding holes 4 are arranged at least in two lines to form a shape of a grid, and each of the current guiding holes 4 has therein at least a current guiding plate 5 having a tilting angle relative to the axial direction of the intake tube 3; when the taking in air flow entering the intake tube 3 gets through the main body 1, it is guided by the current guiding holes 4 and the current guiding plate 5 to rotate and flow in the intake tube 3 in a specific angle, and will not be concentrated at the area far from the axis of the intake tube 3, thereby the amount of the intake air can be uniformly distributed in the axis of the intake tube and the area far from the axis of the intake tube 3.

Although the above conventional current guide solved the problem of having the amount of air flow near the axis of the intake tube 3 and far from the axis of the intake tube 3 distributed un-uniformly, by virtue that the taking in air flow in the intake tube 3 flows very fast to supply air for the engine, a user can not uniformly distribute the air catalyst or the combustion supporting material being added on each air molecule which are flowing very fast, thereby the air catalyst or the combustion supporting material still is unable to develop the best effect of use.

In view of these, the inventor of the present invention studied on the related field and based on his experience of years to provide a car engine air-intake unit in order to solve the above discussed problem, the invention can make the air molecules in the intake tube be scattered more uniformly, and thereby increase the effect of conveniently use.

### SUMMARY OF THE INVENTION

The object of the present invention is to provide a car engine air-intake unit that can strengthen the effect of scattering of the air molecules in the intake tube, and can multiply the effect of scattering of the air molecules, thus an object of achieving convenience of use.

In order to achieve the above-mentioned object, the car engine air-intake unit of the present invention can be provided on the inner rim of an intake tube and comprises at least a main body in a shape of round sheet, the main body is provided thereon with a plurality of current guides and current guiding plates to guide air flow to enter the intake tube and to flow and rotate, and blades are provided to protrude out of the main body and extend from the current guiding plates to increase the rotating angle and stroke of the guided air flow, and more, the main body is provided on an outer surface of the circular ring with an adjusting member to allow the main body to be engaged in an inner rim of one of various intake tubes. Wherein:

The main body has a circular ring which can be fixed on the inner rim of an intake tube, the ring is provided therein with a plurality of current guiding holes, and the current guiding holes each has therein at least a current guiding plate having a tilting angle relative to the axial direction of the intake tube; when the taking in air flow entering the intake tube gets through the main body, it is guided by the current guiding holes and the current guiding plates to rotate and flow in the intake tube in a specific angle, and will not be concentrated at the area far from the axis of the intake tube.

The above mentioned blades are formed to protrude out of the current guiding plates on the main body, when the taking in air flow entering the intake tube of the car is guided by the current guiding holes and the current guiding plates to rotate and flow out of the current guiding holes, the blades will keep on the stroke of guiding and rotating the air flow to increase the rotating angle of the air flow; and when the air flow gets through the blades, it is cut and separated into a plurality of fine vortexes, these fine and disordered vortexes make scattering of the air flow molecules toward everywhere, to thereby make the added air catalyst on the intake end of the intake tube uniformly contact each molecule attached to the air flow.

In practicing, the contour of the blades can match with the bores of the current guiding holes, in order that when two main bodies are leaned against each other, one main body can have its blades engaged in the current guiding holes of the other main body, so that the two main bodies can be connected with each other conveniently.

The above mentioned adjusting member is provided on the outer surface of the above mentioned circular ring, in order that the present invention can freely cooperate with any intake tube among various intake tubes with different bores, to save wasting cost of opening mould. In practicing, the adjusting member can be a “C” shaped ring of any of various thicknesses able to be engaged between the intake tube and the circular ring; by virtue that the “C” shaped ring nestles between the inner rim of the intake tube and the outer surface of the circular ring, it impedes flowing of the air flow in a space between the circular ring and the intake tube, so that the air flow can more concentratively flow from the above mentioned current guiding holes to go along the blades, thereby the air molecules in the intake tube can be assured to be distributed more uniformly.

Moreover, in practicing of the present invention, the taking in end of the main body can be provided with an annular stop piece which can be in a shape of “C” having a notch in order to be engaged in any of various air-intake tubes of different bores, and can impede flowing of the air flow in the space between the circular ring and the intake tube, the annular stop piece can also render the air flow on the end of the intake tube to flow more concentratively to the center of the main body, in order that the turbulence effect of the main body can be more evident.

For the convenience of assembling, in practicing of the present invention, at least an elongate fixing piece can be provided, the elongate fixing piece is provided on one end of it with a blocking piece, the other end of the elongate fixing piece is pulled through a current guiding hole at the lateral side of a main body, and is pulled outwards after passing the top edge of the circular ring of the main body, so that when the blocking piece blocks the taking in end of the main body, the elongate fixing piece is pressed tight by an originally provided element of the air-intake tube of the car, and assembling is completed; and a user can make assembling and disassembling by himself, thus the effect of convenient assembling can be achieved.

As compared with the conventional techniques, in view that the present invention can effectively scatter the air molecules, the air catalytic added to the taking in end can more uniformly contact each molecule attached to the air flow; and the present invention can make assembling and adjusting by using different air taking in amount and any of various air-intake tubes of different bores; it has the advantage of convenience of use.

The present invention will be apparent in its technical measures after reading the detailed description of the preferred embodiment thereof in reference to the accompanying drawings.

### BRIEF DESCRIPTION OF THE DRAWINGS

FIG. 1 is a perspective schematic view showing the structure of a conventional current guide for an engine air-intake;

FIG. 2 is an anatomic perspective view of the present invention;

FIG. 3 is a perspective schematic view showing an intake tube of the present invention;

FIG. 4 is a schematic plan view showing the intake tube of the present invention;

FIG. 5 is a perspective schematic view showing another type of the present invention;

FIG. 6 is an enlarged perspective view showing a rib piece of the present invention;

FIG. 7 is an anatomic perspective view showing a fixing piece of the present invention;

FIG. 8 is a perspective schematic showing use of the fixing piece of the present invention;

FIG. 9 is a schematic plan view showing assembling of the fixing piece of the present invention.

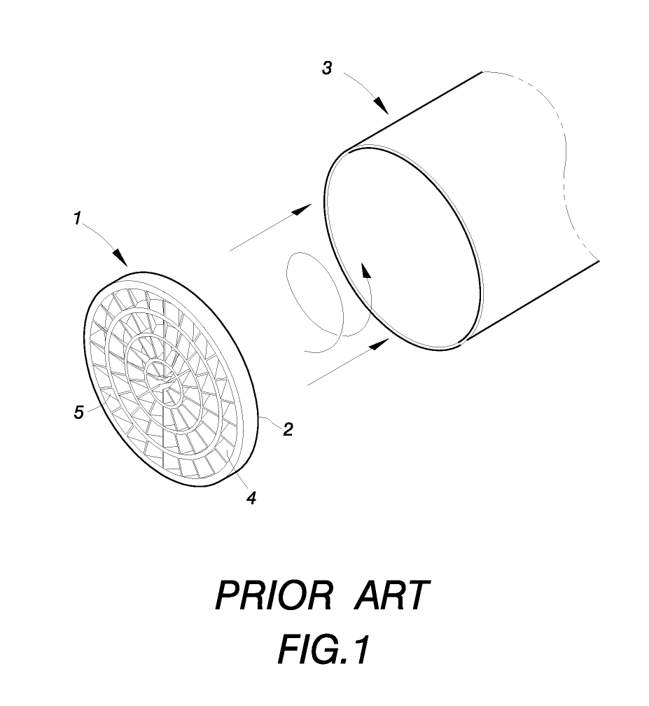

### DETAILED DESCRIPTION OF THE PREFERRED EMBODIMENT

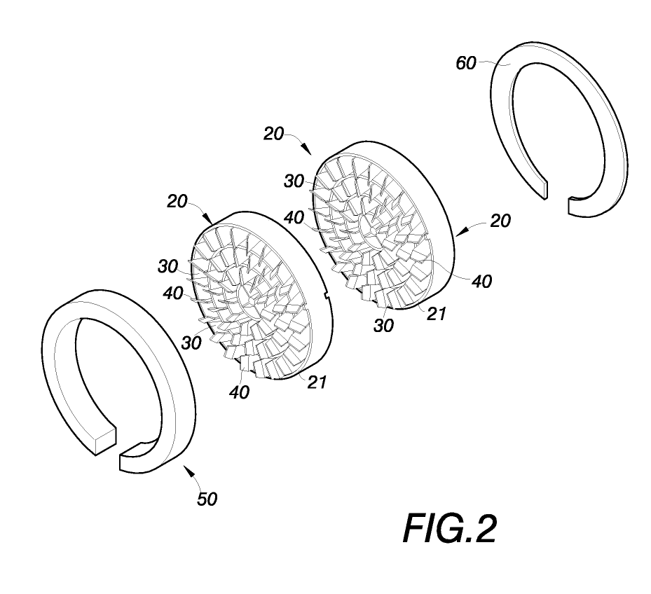

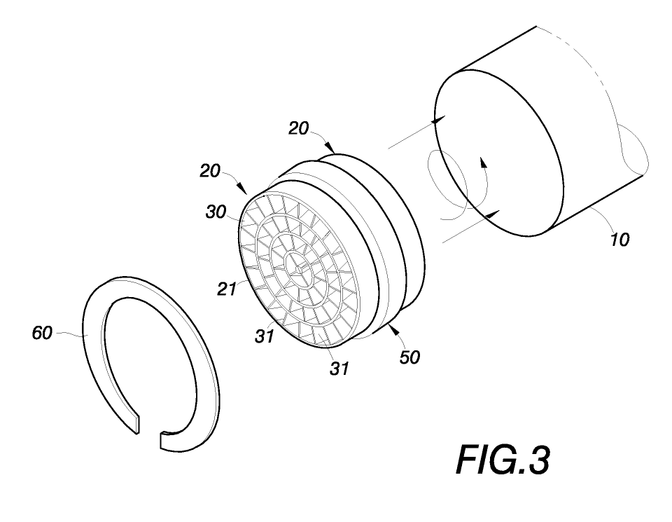

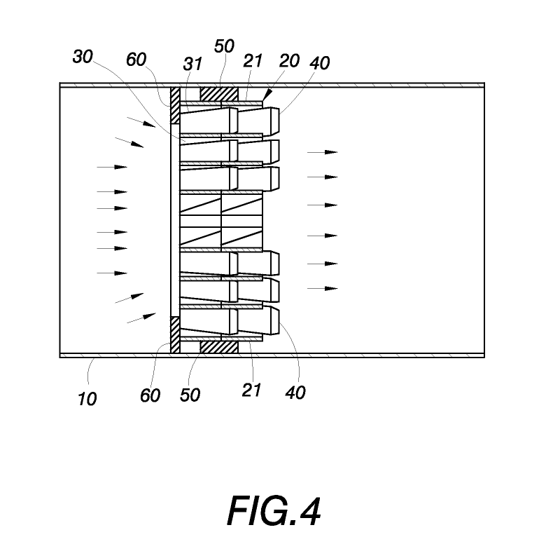

Referring to FIGS. 2 to 4, a car engine air-intake unit of the present invention can be provided in the inner rim of an intake tube 10, and comprises at least a main body 20 in a shape of round sheet, the main body 20 is provided thereon with a plurality of current guides 30 and current guiding plates 31 to guide air flow to enter the intake tube 10 and to flow and rotate, the current guiding plates 31 have blades 40 which protrude out of the main body 20 and extend from the current guiding plates 31 forwards and rearwards to increase the rotating angle and stroke of the guided air flow, and more, the main body 20 is provided on an outer surface of a circular ring 21 with an adjusting member 50 to allow the main body 20 to be engaged in an inner rim of one of various intake tubes 10. The intake end of the main body 20 can be provided with an annular stop piece 60. Wherein:

The main body 20 has therearound the circular ring 21 which can be fixed on the inner rim of an intake tube 10, the ring 21 is provided therein with a plurality of current guiding holes 30, and the current guiding holes 30 each has therein at least a current guiding plate 31 having a tilting angle relative to the axial direction of the intake tube 10; when the taking in air flow entering the intake tube 10 gets through the main body 20, it is guided by the current guiding holes 30 and the current guiding plates 31 to rotate and flow in the intake tube 10 in a specific angle, and will not be concentrated at the area far from the axis of the intake tube 10.

The above mentioned blades 40 are formed to protrude out of the current guiding plates 31 on the main body 20, when the taking in air flow entering the intake tube 10 of the car is guided by the current guiding holes 30 and the current guiding plates 31 to rotate and flow out of the current guiding holes 30, the blades 40 will keep on the stroke of guiding and rotating the air flow to increase the rotating angle of the air flow; and when the air flow gets through the blades 40, it is cut and separated into a plurality of fine vortexes, these fine and disordered vortexes make scattering of the air flow molecules toward everywhere, to thereby make the added air catalyst on the intake end uniformly contact each molecule attached to the air flow.

In practicing, the contour of the blades 40 can match with the bores of the current guiding holes 30, in order that when two main bodies 20 are leaned against each other, one main body 20 can have its blades 40 engaged in the current guiding holes 30 of the other main body 20, so that the two main bodies 20 can be connected with each other conveniently.

The above mentioned adjusting member 50 is provided on the outer surface of the above mentioned circular ring 21, in order that the present invention can freely cooperate with any intake tube 10 among various intake tubes 10 with different bores, to save wasting cost of opening mould. In practicing, the adjusting member 50 can be a “C” shaped ring of any of various thicknesses able to be engaged between the intake tube 10 and the circular ring 21; by virtue that the “C” shaped adjusting member 50 nestles between the inner rim of the intake tube 10 and the outer surface of the circular ring 21, it impedes flowing of the air flow in a space between the circular ring 21 and the intake tube 10, so that the air flow can more concentratively flow from the above mentioned current guiding holes 30 to go along the blades 40, thereby the air molecules in the intake tube 10 can be assured to be distributed more uniformly.

Moreover, in practicing of the present invention, the taking in end of the main body 20 is provided with the above mentioned annular stop piece 60 which can be in a shape of “C” having a notch in order to be engaged in any of various air-intake tubes 10 of different bores, and can impede flowing of the air flow in the space between the circular ring 21 and the intake tube 10, the annular stop piece 60 can also render the air flow on the end of the intake tube 10 to flow more concentratively to the center of the main body 20, in order that the turbulence effect of the main body 20 can be more evident.

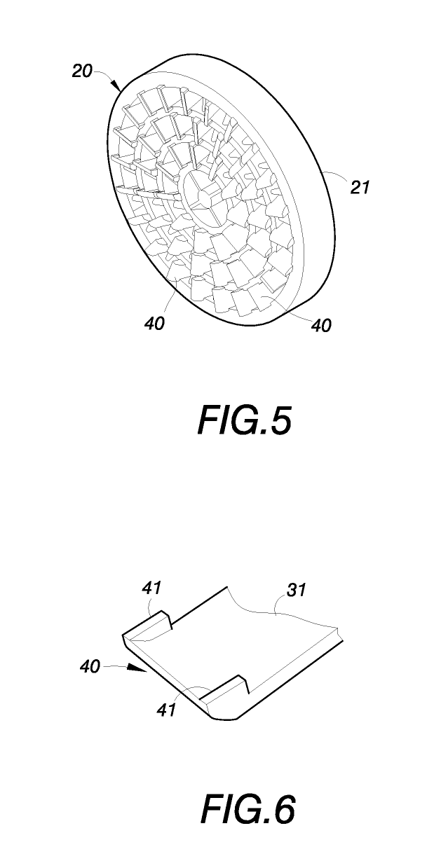

Referring to FIGS. 5 and 6, the blades 40 extend from the current guiding plates 31 forwards and rearwards and each has a contour being arciform or being tilting, in practicing, the blades 40 can be provided each at two sides of its inwardly bending or tiling areas with rib pieces 41 for strengthening their structural strengths, these rib pieces 41 can eliminate the problem of being subject to breaking because of their insufficient strengths or breaking induced in manufacturing.

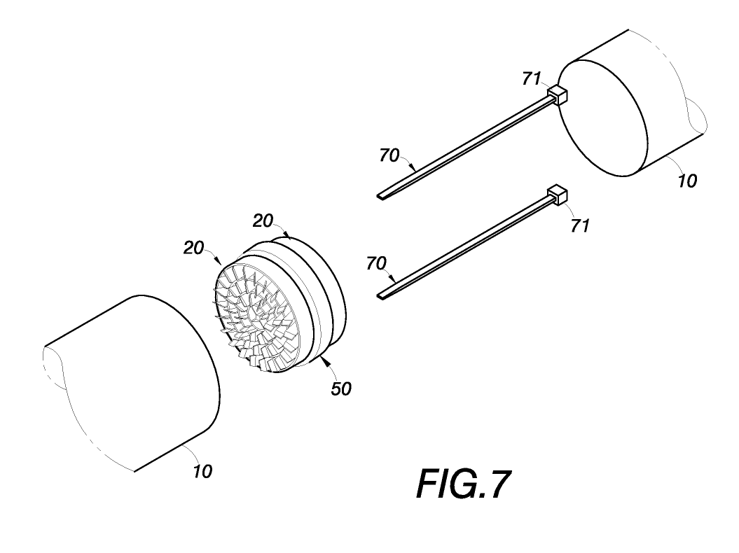

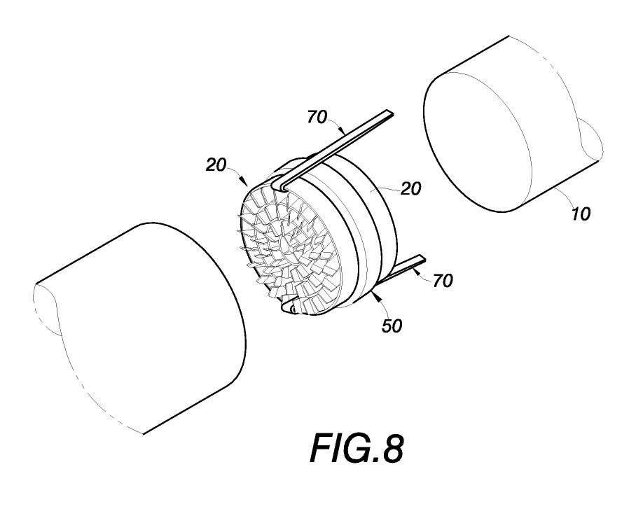

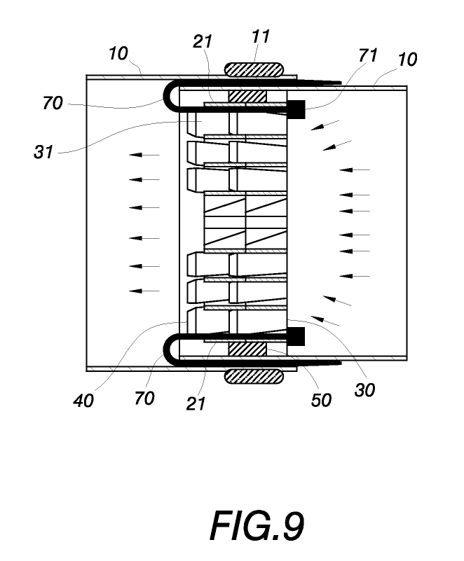

Referring to FIGS. 7 to 9, for the convenience of assembling, in practicing of the present invention, at least an elongate fixing piece 70 can be provided, the elongate fixing piece 70 is provided on one end of it with a blocking piece 71, the other end of the elongate fixing piece 70 is pulled through a current guiding hole 30 at the lateral side of a main body 20, and is pulled outwards after passing the top edge of the circular ring 21 of a main body 20, so that when the blocking piece 71 blocks the taking in end of the main body 20, the elongate fixing piece 70 is pressed tight by an originally provided element 11 of the air-intake tube 10 of the car, and assembling is completed; and a user can make assembling and disassembling by himself, thus the effect of convenient assembling can be achieved. As depicted in the drawings, two elongate fixing pieces 70 are provided respectively on the two lateral sides of the main body 20, for the purpose that the main body 20 can be firmly fixed on the intake tube 10 of the car.

The embodiment given and the content shown in the drawings are only for illustrating a preferred embodiment of the present invention, and not for giving any limitation such as in appearance, modeling (which can be varied in pursuance of the requirement of the shape of the intake tube) to the scope of the present invention. It will be apparent to those skilled in this art that various equivalent modifications or changes without departing from the spirit of this invention shall also fall within the scope of the appended claims.

1. A car engine air-intake unit to be provided in an inner rim of an intake tube, said air-intake unit comprises at least a main body in a shape of round sheet, said main body has therearound a circular ring, said circular ring is provided therein with a plurality of current guiding holes adapted to uniformly scattering air flow, and said current guiding holes each has therein at least a current guiding plate for adjusting direction of said air flow, said current guiding plates have blades which protrude out of said main body and extend from said current guiding plates to increase rotating angle and stroke of said air flow.

2. The car engine air-intake unit as claimed in claim 1, wherein said main body is provided on an outer surface of said circular ring with an adjusting member to be engaged in an inner rim of said intake tube.

3. The car engine air-intake unit as claimed in claim 2, wherein said adjusting member is a “C” shaped ring of any of various thicknesses.

4. The car engine air-intake unit as claimed in claim 1, wherein contours of said blades match with bores of said current guiding holes, in order that they are engaged in current guiding holes of another main body.

5. The car engine air-intake unit as claimed in claim 1, wherein said blades are provided each at two sides with rib pieces for strengthening their structural strengths.

6. The car engine air-intake unit as claimed in claim 1, wherein a taking in end of said main body is provided with an annular stop piece.

7. The car engine air-intake unit as claimed in claim 6, wherein said annular stop piece is in a shape of “C” having a notch.

8. The car engine air-intake unit as claimed in claim 1, wherein at least an elongate fixing piece is provided in a current guiding hole on a lateral side of said main body, said elongate fixing piece is provided on one end of it with a blocking piece, other end of said elongate fixing piece is pulled through said current guiding hole, and is pulled outwards after passing a top edge of said circular ring, so that when the blocking piece blocks said taking in end of said main body, said elongate fixing piece is pressed tight by an originally provided element of said air-intake tube of said car.

9. The car engine air-intake unit as claimed in claim 8, wherein another elongate fixing piece is provided in addition to said elongate fixing piece, said two elongate fixing pieces are allocated at two mutually opposite positions.
